(19) United States
(12) Patent Application Publication
(10) Pub. No.: US 2017/0324270 A1
(43) Pub. Date: Nov. 9, 2017

(54) STANDBY CIRCUIT, AND OUTLET, PLUG, AND DEVICE HAVING THE SAME

(71) Applicants: CALVIN SHIE-NING WANG, Los Angeles, CA (US); ZHEN-QIU HUANG, Cayman Island (KY)

(72) Inventors: CALVIN SHIE-NING WANG, Los Angeles, CA (US); ZHEN-QIU HUANG, Cayman Islands (KY)

(21) Appl. No.: 15/629,717

(22) Filed: Jun. 21, 2017

Related U.S. Application Data
(63) Continuation-in-part of application No. 14/140,551, filed on Dec. 26, 2013.

(30) Foreign Application Priority Data
Dec. 13, 2016 (CN) 201621366610.4
Feb. 24, 2017 (TW) 106202699

(51) Int. Cl. H02J 9/00; H01R 13/70; H01R 25/00; H02J 3/14; H01R 24/76; H02M 1/00

(52) U.S. Cl. CPC H02J 9/005; H02J 3/14; H01R 24/76; H01R 13/70; H01R 25/006; H02M 2001/0032; Y02B 70/16

(57) ABSTRACT

A standby circuit and device to reduce power consumption of appliances in standby mode comprise a power regulator, a power detecting circuit, and a HIC module. The HIC module can control the power regulator to turn off when a detected power consumption of a load is within a predetermined power consumption range.

### CROSS-REFERENCE TO RELATED APPLICATIONS

This application is a continuation-in-part application of U.S. patent application Ser. No. 14/140,551, filed Dec. 26, 2013, the entirety of which is incorporated by reference herein.

### FIELD

The subject matter herein generally relates to power efficiency of electronic appliances. More specifically, the subject matter relates to a standby circuit, and outlet, plug, and device having the same.

### BACKGROUND

Many electronic appliances can be controlled by an infrared controller. A range of standby power consumption of the electronic appliances may generally reach between 1-3 Watts, such as in relation to television, air-conditioner, electric fan, and other office electronic devices.

### BRIEF DESCRIPTION OF THE DRAWINGS

Implementations of the present technology will now be described, by way of example only, with reference to the attached figures.

FIG. 1 is a block diagram of a standby circuit of the present disclosure, wherein the standby circuit comprises a thick film hybrid integrated circuit (HIC) module.

FIG. 2 is a schematic diagram of a standby device of the present disclosure.

FIG. 3 is a block diagram of the HIC module of FIG. 1.

FIG. 4 is a schematic diagram of a standby outlet coupled to an electronic appliance.

FIG. 5 is a schematic diagram of a standby plug coupled to an electronic appliance.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently coupled or releasably coupled. The term “comprising,” when utilized, means “including, but not necessarily limited to”; it specifically indicates open-ended inclusion or membership in the so-described combination, group, series and the like.

The present disclosure is described in relation to reducing power consumption of electronic devices.

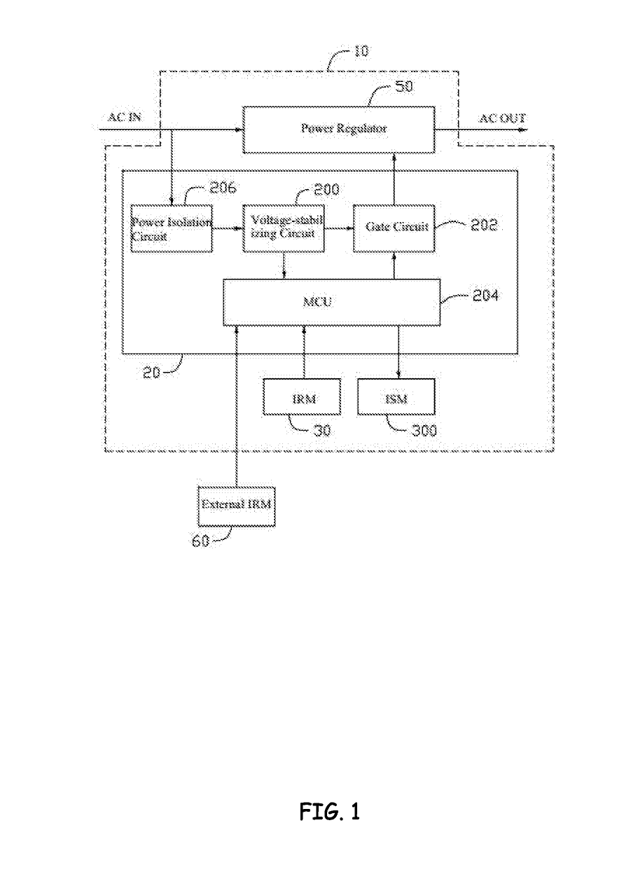

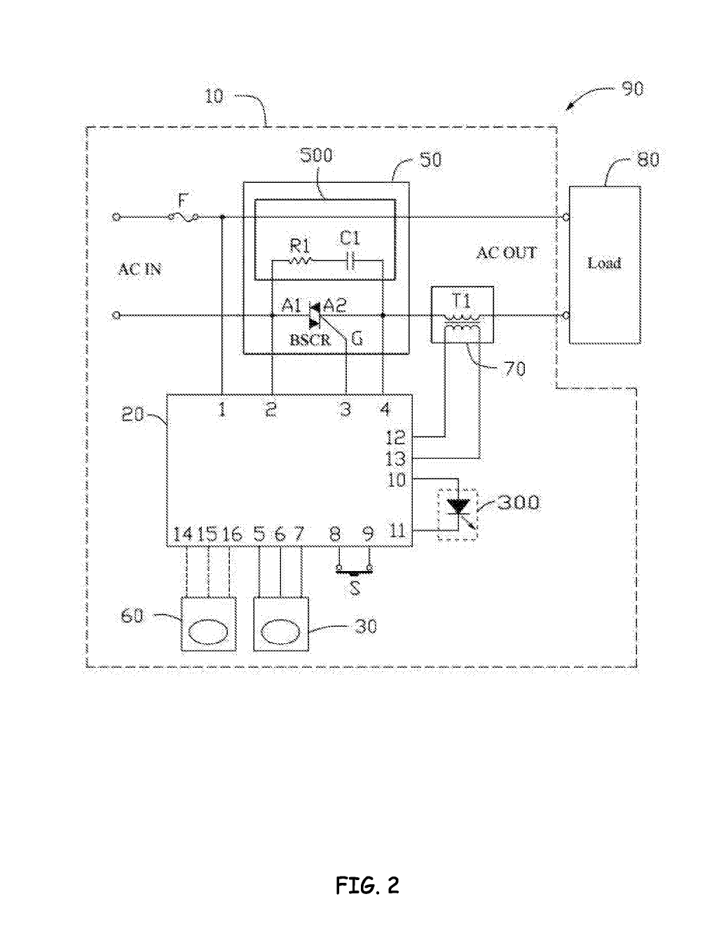

FIG. 1 illustrates a standby circuit 10 of the present disclosure. The standby circuit 10 can comprise a thick film hybrid integrated circuit (HIC) module 20, a power detecting circuit 70 (shown in FIG. 2), and a power regulator 50.

FIG. 2 illustrates a standby device 90 of the present disclosure. The standby device 90 can comprise the standby circuit 10, and at least one load 80. In at least one embodiment, the standby device 90 can be, but is not limited to, a television, an air conditioner, an electric fan, a refrigerator, a washing machine, or audio electronics. The standby circuit 10 can be arranged in a power socket of the standby device 90 or a main body of the standby device 90.

The power regulator 50 can be coupled to an AC power source. The power detecting circuit 70 can be coupled between the power regulator 50 and the load 80. In one embodiment of the present disclosure, the power regulator 50 can be in an on state or off state, for connecting or disconnecting, respectively, the AC power source to the load 80.

The power detecting circuit 70 can detect a power requirement of the load 80 and output the power to the HIC module 20.

The HIC module 20 can comprise a first pin (pin 1), a second pin (pin 2), a third pin (pin 3), a fourth pin (pin 4), a fifth pin (pin 5), a sixth pin (pin 6), a seventh pin (pin 7), an eighth pin (pin 8), a ninth pin (pin 9), a tenth pin (pin 10), a eleventh pin (pin 11), a twelfth pin (pin 12), a thirteenth pin (pin 13), a fourteenth pin (pin 14), a fifteenth pin (pin 15), and a sixteenth pin (pin 16).

In at least one embodiment, the power detecting circuit 70 can comprise a transformer T1. A primary coil of the transformer T1 can be connected between the power regulator 50 and the load 80. A secondary coil of the transformer T1 can be connected to the pin 12 and pin 13 of the HIC module 20. Therefore, when the transformer T1 is connected for transmitting AC power, the secondary coil of the transformer T1 can output a current through pin 12 and pin 13 of the HIC module 20 (the twelfth pin and the thirteenth pin of the HIC module 20).

In at least one embodiment, the HIC module 20 can receive the output current of the secondary coil of the transformer T1 and detect the voltage of the AC power source, so as to calculate the power consumption of the load 80. The HIC module 20 can determine an operating mode of the load 80 according to the power consumption. In at least one embodiment, when the power consumption of the load 80 is within a predetermined range (e.g., 1-3 W), the HIC module 20 can determine that the load 80 can be in the standby mode. If the power of the load 80 is larger than an upper bound (e.g., 3 W) of the predetermined range, the HIC module 20 can determine that the load 80 can be in the operating mode.

In addition, the HIC module 20 can control the state of the power regulator 50 (i.e. the “on” state and the “off” state) based on the operating mode of the load 80 (e.g., the standby mode and the operating mode). For example, the HIC module 20 can control the power regulator 50 to be in the off state when the load 80 is in the standby mode, so as to turn off the power from the AC power source to the load 80, thereby reducing the power consumption of the load 80 when the load 80 is in the standby mode.

It should be noted that the HIC module 20, the power detecting circuit 70, and the power regulator 50 can be installed in an appliance, such as a TV, an air conditioner, an electronic fan, and/or other appliances.

In at least one embodiment, the standby circuit 10 can comprise an IRM (Infrared Receive Module) 30 and an ISM (Infrared Send Module) 300. A first interface (pin 5 to pin 7) of the HIC module 20 can couple to the IRM 30. A second interface (pin 10 and pin 11) of the HIC module 20 can couple to the SIM 300. A third interface (pin 14 to pin 16) of the HIC module 20 can couple to an external IRM 60. In at least one embodiment, the standby circuit 10 can further comprise the external IRM 60.

The HIC module 20 can receive at least one command (such as an on command or an off command) from a remote commander through the first interface or the third interface. The HIC module 20 can output an infrared signal through the second interface.

In at least one embodiment, the HIC module 20 can determine a priority between the first interface and the third interface, and receive the command from the remote commander based on the priority of the first and third interfaces. For example, the first interface can be configured to have a first priority, and the second interface can be configured to have a second priority. When the HIC module 20 cannot receive the command through the first interface, the HIC module 20 can select the third interface, having the second priority, to receive the command. Accordingly, the HIC module 20 can communicate with the remote commander through the third interface. Otherwise, the HIC module 20 can receive the command through the first interface.

In at least one embodiment, the HIC module 20 can receive the at least one command from the remote commander through other types of communication interface, such as the communication interface of WI-FI or ZIGBEE.

In at least one embodiment, after receiving the off command from the remote commander, the HIC module 20 can further determine whether the load 80 is in the off state according to the output power.

In one situation, when the power of the load 80 is larger than the upper bound of the predetermined range, the HIC module 20 can delay the first predetermined time before the HIC module 20 outputs the off control signal to the power regulator 50. Then, the load 80 can switch to the standby mode within the first predetermined time period.

In another situation, when the power of the load 80 is within the predetermined range, the HIC module 20 can output the off control signal to the power regulator 50 after receiving the off command.

In at least one embodiment, after receiving the on command from the remote commander, the HIC module 20 can output an on control signal to the power regulator 50 to control the power regulator 50 to be in the “on” state. Accordingly, the load 80 can connect to the AC power source and switch to the operating mode.

In at least one embodiment, after receiving the on command, the HIC module 20 can delay a second predetermined time to obtain the power consumption of the load 80. The HIC module 20 can further determine whether the power of the load 80 is larger than the upper bound of the predetermined range. When the power of the load 80 is larger than the upper bound of the predetermined range, the load 80 can be in a normal state of the operating mode. When the power of the load 80 is within the predetermined range, the load 80 can be in an abnormal state of the operating mode, the HIC module 20 can output a warning signal accordingly.

In at least one embodiment, the power regulator 50 can comprise a bi-directional silicon controlled rectifier (BSCR) and a resistor-capacitor (RC) circuit 500. A first anode A1 of the BSCR and a second anode A2 of the BSCR can couple to the wire connecting the AC power source. A control gate G of the BSCR can couple to pin 3 of the HIC module 20 (the third pin of the HIC module 20) to receive the on control signal or the off control signal. When the BSCR receives the off control signal from the HIC module 20, the power regulator 50 of the BSCR can switch to the off state. When the BSCR receives the on control signal from the HIC module 20, the power regulator 50 of the BSCR can switch to the on state, so that the AC power source provides power to the load 80.

The RC circuit 500 can be used to filter a signal by blocking certain frequencies and passing others. The RC circuit 500 can comprise a resistor R1 and a capacitor C1. The resistor R1 can be connected in series with the capacitor C1, and the RC circuit 500 can be connected in parallel with the first anode A1 of the BSCR and the second anode of the BSCR. The resistor R1 can be connected to pin 2 of the HIC module 20 (the second pin of the HIC module 20), and the capacitor C1 can be connected to pin 4 of the HIC module 20 (the fourth pin of the HIC module 20). In other embodiments, the power regulator 50 may not comprise the RC circuit 500.

Pin 8 and pin 9 of the HIC module 20 (the eighth pin and the ninth pin of the HIC module 20) can be connected to a switch S, and the switch S can be used to reset the HIC module 20. Pin 10 and pin 11 of the HIC module 20 (the tenth pin and the eleventh pin of the HIC module 20) can be used to connect to SIM 300, so as to apply a latency in sending infrared signal. In at least one embodiment, the Pin 10 and pin 11 of the HIC module 20 can be connected to a DC (direct current) power source 40. For example, a battery power source, a capacitor power source, or a DC power source from the feedback of the load 80 can be connected to the pin 10 and pin 11.

In at least one embodiment, the standby circuit 10 can further comprise a protecting device F. The protecting device F can be installed and connected to the AC power source so as to protect the load 80. The protecting device F can be a fuse.

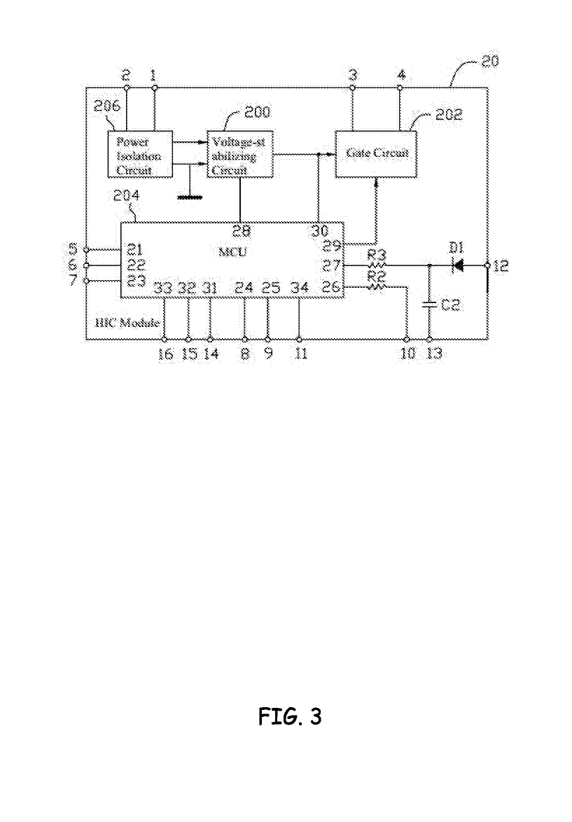

FIGS. 1 and 3 illustrate that the HIC module 20 can comprise an MCU (Micro Controller Unit) 204, a voltage-stabilizing circuit 200, a gate circuit 202, and a power isolation circuit 206.

The MCU 204 can store a plurality of programs to be executed, to perform certain functions, such as calculation, comparison, and analysis. The MCU 204 can be able to control the switch action of component in the HIC module 20, thus reducing power standby consumption. In at least one embodiment, the MCU 204 can comprise a first pin to a fourteenth pin (pin 21 to a pin 34).

Pin 21, pin 22, and pin 23 of the MCU 204 can be respectively connected to pin 5, pin 6, and pin 7 of the HIC module 20. The MCU 204 can receive a signal through the first interface (pin 5, pin 6, and pin 7) of the HIC module 20.

Pin 24 and pin 25 of the MCU 204 can be respectively connected to pin 8 and pin 9 of the HIC module 20, so as to reset the MCU 204 through the switch S.

Pin 26 of the MCU 204 (the sixth pin of the MCU 204) can be connected to pin 10 of the HIC module 20 via the resistor R2, to couple to an anode of the RSM 300. Pin 34 of the MCU 204 can be connected to pin 11 of the HIC module 20, to couple to the cathode of the RSM 300.

A first terminal and second terminal of the power isolation circuit 206 can respectively couple to the pin 1 and pin 2 of the HIC module 20, to couple to a live line and a neutral line, respectively, of the AC power source. The power isolation circuit 206 can convert the AC power to a direct current (DC) power, and transmit the DC power to the voltage-stabilizing circuit 200.

The voltage-stabilizing circuit 200 can perform a voltage stabilization operation on the DC power. The voltage-stabilizing circuit 200 can output a stabilization power to a gate circuit 200 and the MCU 204, to provide power for the gate circuit 200, and the MCU 204.

Pin 27 of the MCU 204 (the seventh pin of the MCU 204) can be connected to the pin 12 of the HIC module 20 through a diode D1 and a resistor R3, and couple to the pin 13 of the HIC module 20 through the resistor R3 and a capacitor C2. In at least one embodiment, the pin 27 of the MCU 204 is coupled to a first terminal of the resistor R3, a second terminal of the resistor R3 is coupled to a cathode of the diode D1, and an anode of the diode D1 is coupled to the pin 12 of the HIC module 20. The capacitor C2 is coupled between a node of the resistor R3 and the diode D1, and the pin 13 of the HIC module 20, to receive the output current of the transformer T1.

Pin 28 of the MCU 204 (the eighth pin of the MCU 204) can be connected to the voltage-stabilizing circuit 200, to output an operation signal to the voltage-stabilizing circuit 200. For example, when an operating mode of the MCU 204 switches from a sleep mode to a wake-up mode, the MCU 204 can output a first operation signal to the voltage-stabilizing circuit 200 through the pin 28 of the MCU. The voltage-stabilizing circuit 200 can perform the voltage stabilizing operation as receive the first operation signal. When the operating mode of the MCU 204 switches from the wake-up mode to the sleep mode, the MCU 204 can output a second operation signal to the voltage stabilizing circuit 200 through the pin 28 of the MCU 204. The voltage-stabilizing circuit 200 can output a sleep signal to the MCU 204, to put in the sleep mode. In at least one embodiment, the voltage-stabilizing circuit 200 can output the sleep signal to the MCU 204 through the pin 30 of the MCU 204.

Pin 29 of the MCU 204 (the ninth pin of the MCU 204) can be connected to the gate circuit 202 to provide a control signal to the gate circuit 202. The gate circuit 202 can be connected to pin 3 and pin 4 of the HIC module 20. The gate circuit 202 can be a switch control component that triggers the mode of the power regulator 50, such as the on state or the off state.

Pin 31 to pin 33 of the MCU 204 can couple to the pin 14 to pin 16 of the HIC module 20, respectively, to receive the commands through the external SIM 60.

In at least one embodiment, the MCU 204 can be in the sleep mode or in the wake-up mode, so that the HIC module 20 can operate in different modes according to the operating mode of the MCU 204.

For example, after receiving the off command from the remote commander, the MCU 204 can control the BSCR to the off state, and the MCU 204 can switch to the sleep mode, so the HIC module 20 can also enter into the sleep mode. Accordingly, the MCU 204 can reduce its power consumption and further reduce standby power consumption.

After receiving the on command, the MCU 204 can switch to the wake-up mode from the sleep mode. Accordingly, the HIC module 20 can enter into the wake-up mode. The HIC module 20 can further control the BSCR to be in the on state. Hence, the load 80 can be connected to the AC power source and revert to the operating mode.

At least one embodiment, after receiving the on command through the pin 21 to pin 23 or the pin 31 to 33, the MCU 204 can switch from the sleep mode to the wake-up mode. When the MCU 204 switches to the wake-up mode, the MCU 204 can output the first operation signal to the voltage-stabilizing circuit 200. The voltage-stabilizing circuit 200 can receive the first operation signal, and output the stabilizing power to the MCU 204, to provide a start-up current to the MCU 204 and the gate circuit 202.

The start-up current can continue for a milliseconds period, such as 1 to at least 10 milliseconds. The MCU 204 can provide the control signal to the gate circuit 202 through pin 29, and control the power regulator 50 to be in the on state. Once the power regulator 50 switches to the on state, the load 80 can obtain the power from the AC power source to start operating in the operating mode.

In view of the above, the system and device for reducing standby power consumption have the HIC module 20 and the power regulator 50 installed inside the appliances.

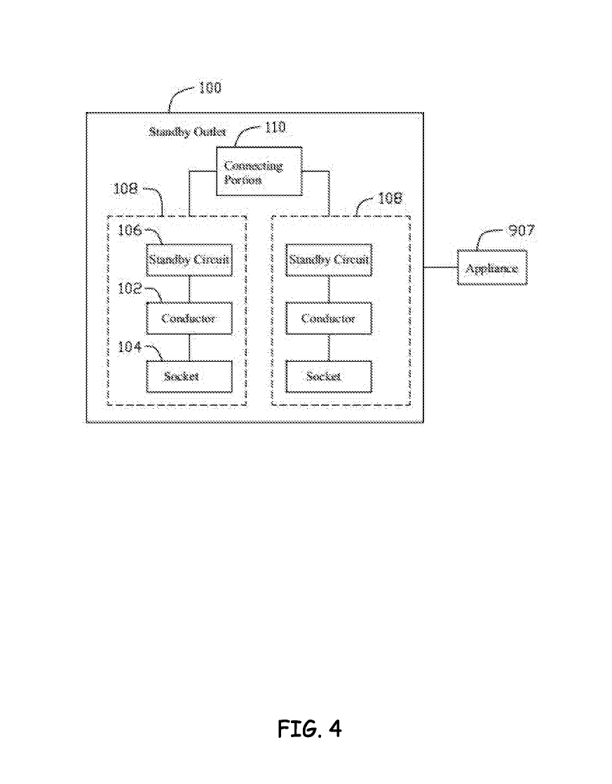

FIG. 4 illustrates a standby outlet 100 of the present disclosure. The standby outlet 100 can connect to portion 110, and at least one outlet unit 108. The connecting portion 110 can couple to an AC power source. The connecting portion 110 can couple to each outlet unit 108, to provide power to each outlet unit 108.

Each outlet unit 108 can comprise a standby circuit 106, a least one conductor 102, and at least one socket 104. The conductor 102 of each outlet unit 108 can couple to the connecting portion 110. The standby circuit 106 can be arranged between the connecting portion 110 and the corresponding conductor 102. An electronic appliance 907 can couple to the conductor 102 of corresponding outlet unit 108, to receive operating power. The standby circuit 106 performs the same function as the standby circuit 10 in FIG. 1.

In at least one embodiment, the connecting portion 110 of the standby outlet 100 can couple to each outlet unit 108 through a wire. The connecting portion 110 and the outlet unit 108 can be arranged in a housing or shell, forming a power adapter. The electronic appliance 907 can be plugged into the power adapter.

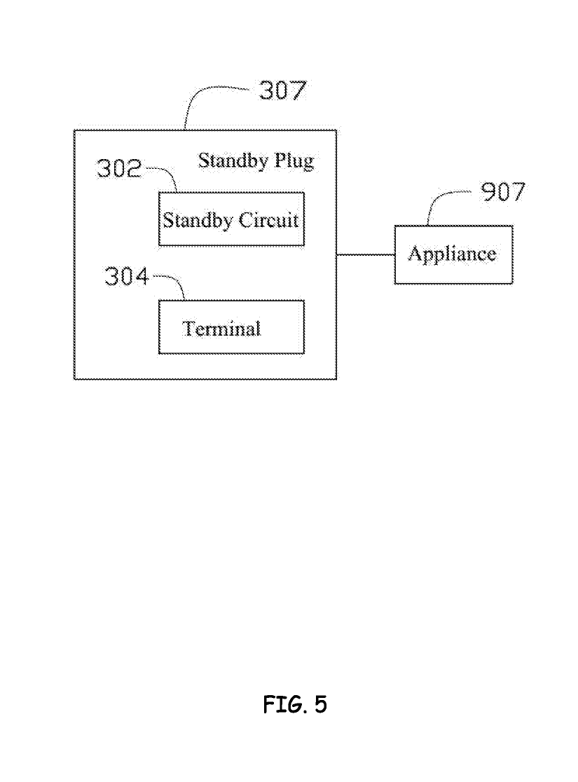

FIG. 5 illustrates a standby plug 307 of the present disclosure. The standby plug 307 can comprise a standby circuit 302 and a plurality of terminals 304. In at least one embodiment, the standby circuit 302 can perform the same function as the standby circuit 10 in FIG. 1.

The plurality of terminals 304 can be arranged in sockets. The sockets can be different types, such as a two-socket type or a three-socket type. For example, the two-socket type can comprise a live line terminal and a neutral line terminal. The three-socket type can comprise a live line terminal, a neutral line, and a ground line terminal. The terminals 304 of the standby plug 307 can be coupled to the electronic appliance.

While the disclosure has been described by way of example and in terms of a preferred embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A standby circuit, connecting to an alternating current (AC) power source, comprising:
a power regulator, being capable of operating in an on state or an off state;
a power detecting circuit, detecting a power of a load; and
a thick film hybrid integrated circuit (HIC) module, comprising:
a first interface, configured to receiving a first command or a second command; and
a second interface, configured to receiving the first command or the second command;
wherein the HIC module determines a priority between the first interface and the second interface, when the HIC module fails to receive the first command or the second command through the first interface, the HIC module receives the first command or the second command through the second interface;
wherein the HIC module determines an operating mode of the load according to the power outputted by the power detecting circuit, the HIC module outputs an off control signal to the power regulator to switch the power regulator into an off state, in response to the power of the load being within a predetermined range.

2. The standby circuit of claim 1, wherein when the HIC module receives the first command, the HIC module determines the operating mode of the load according to the power, when the load is in an operating mode, the HIC module delays a first predetermined time to output the off control signal to the power regulator; when the load is in a standby mode, the HIC module outputs the off control signal to the power regulator; wherein when the HIC module receives the second command, the HIC module outputs an on control signal to the power regulator, the power regulator operates in the on state.

3. The standby circuit of claim 2, wherein when the HIC module outputs the off control signal, the HIC module operates in a sleep mode, and when the HIC module outputs the on control signal, the HIC module operates in a weak-up mode.

4. The standby circuit of claim 3, wherein the HIC module delays a second predetermined time to determine whether the power of the load is larger than an upper bound of the predetermined range when outputting the on control signal to power regulator, and when the power of the load is less than the upper bound of the predetermined range, the HIC outputs a warning signal.

5. The standby circuit of claim 2, wherein the HIC module comprises:
a micro control unit (MCU), configured to receive the first command or the second command; and
a gate circuit, configured to output the on control signal or the off control signal according a gate control signal outputted by the MCU;
wherein when the MCU receives the first command, the gate circuit outputs the off control signal, when the MCU receives the second command, the gate circuit outputs the on control signal.

6. The standby circuit of claim 5, wherein the HIC module further comprises:
a power isolation circuit, configured to convert a AC power to a direct current (DC) power; and
a voltage-stabilizing circuit, configured to perform a voltage stabilizing operation on the DC power;
wherein when the MCU receives the second command, the MCU controls the voltage-stabilizing circuit to output a start-up current to the MCU.

7. The standby circuit of claim 6, wherein when the MCU receives the start-up current, the MCU controls the gate circuit to output the on control signal to the power regulator.

8. The standby circuit of claim 1, wherein the power detecting circuit comprises a transformer, wherein the transformer has a primary coil connected to the load and a secondary coil of the transformer connected to the HIC module, the transformer generates an output current corresponding to the power of the load, the HIC module calculates the power of the load according to output current of the transformer.

9. The standby circuit of claim 1, wherein the first interface connects an infrared receive module, the second interface connects an external infrared receive module.

10. The standby circuit of claim 9, wherein the HIC module further comprise a third interface, wherein the interface connects an infrared send module, the HIC module delays a sending signal through the third interface.

11. The standby circuit of claim 1, wherein the power regulator comprises a bi-directional silicon controlled rectifier (BSCR), wherein a first anode of the BSCR and a second anode of the BSCR are connected to the AC power source, a control gate of the BSCR is connected to the HIC module; wherein the BSCR is switched to an off state after receiving the off control signal from the HIC module, or the BSCR is switched to an on state after receiving the on control signal from the HIC module.

12. The standby circuit of claim 11, wherein the power regulator further comprises a RC circuit, wherein the RC circuit has a first resistor and a first capacitor, a first anode of the BSCR couples to a second anode of the BSCR through the resistor and the capacitor connected in serial.

13. A standby outlet, comprising:
a connecting portion; and
at least one socket unit, coupling to the connecting portion, wherein the socket unit comprises:
a plurality of conductors;
a socket; and
a standby circuit, setting forth as claim 1;
wherein the plurality of conductors couple to the connecting portion, the standby circuit arranges between the connecting portion and the plurality of conductors, a power detecting circuit of the standby circuit detects a power of a load through the plurality of conductors.

14. A standby plug, comprising:
a plurality of terminals; and
a standby circuit, setting forth as claim 1;
wherein the plurality of terminals selectively couples to an AC power source and a load, a power detecting circuit of the standby circuit detects a power of a load through the plurality of terminals.

15. A standby device, comprising:
a load;
a power regulator, being capable of operating in an on state or an off state;
a power detecting circuit, detecting a power of the load; and
a thick film hybrid integrated circuit (HIC) module, comprising:
a first interface, configured to receiving a first command or a second command; and
a second interface, configured to receiving the first command or the second command;
wherein the HIC module determines a priority between the first interface and the second interface, when the HIC module fails to receive the first command or the second command through the first interface, the HIC module receives the first command or the second command through the second interface;
wherein the HIC module determines an operating mode of the load according to the power outputted by the power detecting circuit, the HIC module outputs an off control signal to the power regulator to switch the power regulator into an off state, in response to the power of the load being within a predetermined range.

16. The standby device of claim 15, wherein when the HIC module receives the first command, the HIC module determines the operating mode of the load according to the power, when the load is in an operating mode, the HIC module delays a first predetermined time to output the off control signal to the power regulator; when the load is in a standby mode, the HIC module outputs the off control signal to the power regulator; wherein when the HIC module receives the second command, the HIC module outputs an on control signal to the power regulator, the power regulator operates in the on state.

17. The standby device of claim 16, wherein when the HIC module outputs the off control signal, the HIC module operates in a sleep mode, and when the HIC module outputs the on control signal, the HIC module operates in a weak-up mode.

18. The standby device of claim 17, wherein the HIC module delays a second predetermined time to determine whether the power of the load is larger than an upper bound of the predetermined range when outputting the on control signal to power regulator, and when the power of the load is less than the upper bound of the predetermined range, the HIC outputs a warning signal.

19. The standby device of claim 14, wherein the HIC module comprises:
a micro control unit (MCU), configured to receive the first command or the second command; and
a gate circuit, configured to output the on control signal or the off control signal according a gate control signal outputted by the MCU;
wherein when the MCU receives the first command, the gate circuit outputs the off control signal, when the MCU receives the second command, the gate circuit outputs the on control signal.

20. The standby device of claim 19, wherein the HIC module further comprises:
a power isolation circuit, configured to convert a AC power to a direct current (DC) power; and
a voltage-stabilizing circuit, configured to perform a voltage stabilizing operation on the DC power;
wherein when the MCU receives the second command, the MCU controls the voltage-stabilizing circuit to output a start-up current to the MCU.
